(19) United States
(12) Patent Application Publication
(10) Pub. No.: US 2015/0081456 A1
(43) Pub. Date: Mar. 19, 2015

(54) SERVICE PROVIDING APPARATUS AND SERVICE PROVIDING METHOD

(71) Applicant: YAHOO JAPAN CORPORATION, Tokyo (JP)

(72) Inventors: Toru TAKATA, Tokyo (JP); Nobuyuki AKASHI, Tokyo (JP); Akira TAJIMA, Tokyo (JP); Koji TSUKAMOTO, Tokyo (JP); Nari WOO, Tokyo (JP); Akihiro TANABE, Tokyo (JP); Shinichiro SEGA, Tokyo (JP)

(21) Appl. No.: 14/332,972

(22) Filed: Jul. 16, 2014

(30) Foreign Application Priority Data
Sep. 19, 2013 (JP) 2013-194669

(51) Int. Cl. G06Q 30/02

(52) U.S. Cl. CPC G06Q 30/0275
USPC 705/14.71

(57) ABSTRACT

A service providing apparatus has a plan receiving unit and a service providing unit. The plan receiving unit receives advertising space information relating to an advertising space set to content by a content creator who creates the content and a targeting condition set to the advertising space by the content creator. The service providing unit provides an auction service in which a bid target is a right to display an advertisement in the advertising space for each targeting condition on the basis of the advertising space information received by the receiving unit.

### CROSS-REFERENCE TO RELATED APPLICATIONS

The present application claims priority to and incorporates by reference the entire contents of Japanese Patent Application No 2013-194669 filed in Japan on Sep. 19, 2013.

### BACKGROUND OF THE INVENTION

1. Field of the Invention

The present invention relates to a service providing apparatus and a service providing method.

2. Description of the Related Art

A distribution service has been known which distributes various kinds of content to a terminal apparatus of the user through the Internet. As an example of the distribution service, a moving image distribution service has been known which distributes moving image content and advertising content which is displayed in a display area of the moving image content.

In regard to the moving image distribution service, a technique called a program auction has been proposed. Specifically, in the program auction, sponsors bid for a given amount of investment money and only the sponsor who bids against the other sponsors has a broadcast right to a CM space for broadcasting hours. This program auction is used to make a definite promise to ensure funds beforehand.

However, in the related art, it is not always possible to provide value-added services for advertisers. Specifically, in the known art described above, advertisers simply compete for the broadcast rights for the CM space in the auction. For this reason, it is difficult to provide value-added services to the advertisers attending the auction.

### SUMMARY OF THE INVENTION

It is an object of the present invention to at least partially solve the problems in the conventional technology.

According to one aspect of an embodiment, a service providing apparatus includes a receiving unit configured to receive advertising space information relating to an advertising space set to content by a content creator who creates the content and a targeting condition set to the advertising space by the content creator; and a providing unit configured to provide an auction service in which a bid target is a right to display an advertisement in the advertising space for each targeting condition on the basis of the advertising space information received by the receiving unit.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a diagram illustrating an example of a service providing process according to a first embodiment;

FIG. 2 is a diagram illustrating an example of a structure of a service providing system according to the first embodiment;

FIG. 3 is a diagram illustrating an example of a structure of a service providing apparatus according to the first embodiment;

FIG. 4 is a diagram illustrating an example of an auction storage unit according to the first embodiment;

FIG. 5 is a diagram illustrating an example of an auction page according to the first embodiment;

FIG. 6 is a diagram illustrating an example of a winning bidder determination process performed by a service providing unit according to the first embodiment;

FIG. 7 is a diagram illustrating an example of a winning bidder determination process performed by the service providing unit according to the first embodiment;

FIG. 8 is a diagram of a sequence diagram illustrating a service providing procedure performed by the service providing system according to the first embodiment;

FIG. 9 is a diagram illustrating an example of a structure of a service providing apparatus according to a second embodiment;

FIG. 10 is a diagram illustrating an example of an auction storage unit according to the second embodiment;

FIG. 11 is a diagram illustrating an example of a history information storage unit according to the second embodiment;

FIG. 12 is a diagram illustrating an example of an auction page according to the second embodiment;

FIG. 13 is a diagram illustrating an example of an auction storage unit according to a modified example;

FIG. 14 is a diagram illustrating an example of content according to a modified example; and

FIG. 15 is a hardware block diagram illustrating an example of a computer for realize the function of the service providing apparatus.

### DETAILED DESCRIPTION OF THE PREFERRED EMBODIMENTS

Hereinafter, a service providing apparatus, a service providing method, and a service providing program according to exemplary embodiment (hereinafter, referred to as an “embodiment”) will be described in detail with reference to the accompanying drawings. In addition, the service providing apparatus, the service providing method, and the service providing program are not limited by the embodiment. In the following embodiments, the same components are denoted by the same reference numerals and the description thereof will, not be repeated.

### First Embodiment

### 1. Service Providing Process

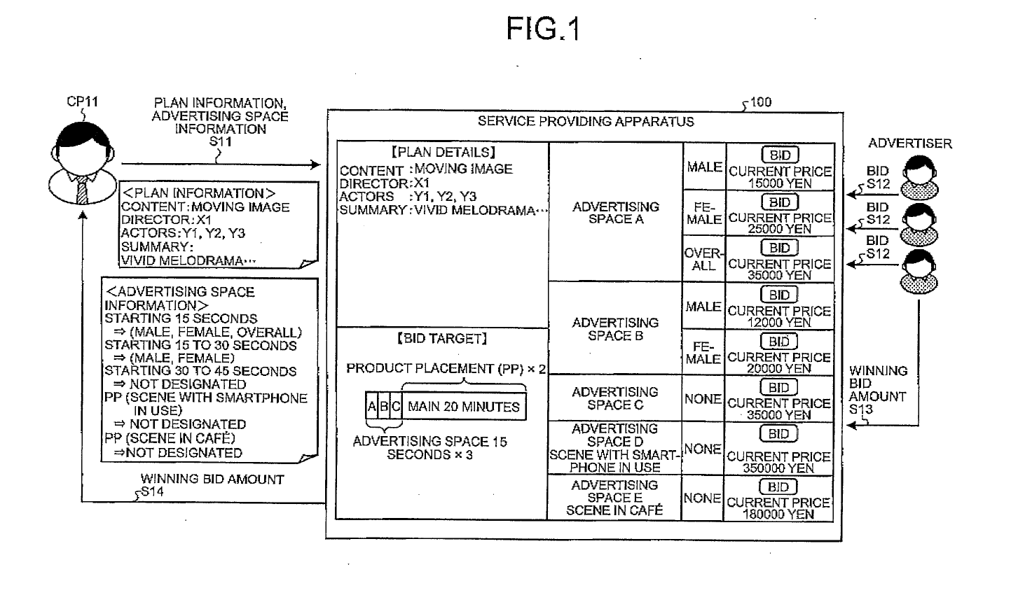

First, an example of the service providing process according to a first embodiment will be described with reference to FIG. 1. FIG. 1 is a diagram illustrating an example of the service providing process according to the first embodiment. In the example illustrated in FIG. 1, a content creator who creates content sets an advertising space to the content and as well sets, to the advertising space, a targeting condition that is a condition for displaying the advertisement. Then, a service providing apparatus 100 illustrated in FIG. 1 provides an auction service in which a bid target, that is an item to be auctioned off, is the right to display an advertisement in the advertising space for each targeting condition that has been set by the content creator. Note that the targeting condition is the information to be used to determine the destination user of content and applies, for example, to the user attribute of the destination user. The description below illustrates an example of the service providing apparatus 100 which provides an auction service in the stage where the content creator plans to create content. Hereinafter, a moving image is given as an example of content.

As illustrated in FIG. 1, the service providing apparatus 100 receives plan information indicating a plan of a moving image and the advertising space information relating to an advertising space which is set to the moving image by the content creator CP11, from a content creator CP11 who plans to create the moving image (step S11). In the following description, in some cases, the plan of content (for example, the moving image) is referred to as a “content-plan”. In addition, the service providing apparatus 100 may receive the plan information and the advertising space information at the same time or at different times.

In the case of the example of FIG. 1, the plan information transmitted by the content creator CP11 includes information indicating that the type of the content is a moving image, the director of the moving image is “X1”, the actors of the moving image are “Y1”, “Y2”, and “Y3”, and the summary of the moving image is a “vivid melodrama”.

Furthermore, the advertising space information transmitted by the content creator CP11 includes information relating to three advertising spaces which are set to the beginning of the moving image, an advertising space which is set to a scene in which a smart phone is used among various kinds of scenes included in the moving image, and an advertising space which is set to a café scene. Furthermore, in the case of the example of FIG. 1, the first one of the three advertising spaces at the beginning includes the setting of “male”, “female”, and “overall (i.e., both male and female)” as a targeting condition. Furthermore, the second one of the three advertising spaces at the beginning includes the setting of “male” and “female” as a targeting condition. On the other hand, the other advertising spaces include no setting of a targeting condition.

Note that one of the aforementioned advertising spaces that is set to the scene in which a smart phone is used or the advertising space set to the scene of the café indicates a cast frame to make a product that an advertiser desires to advertise appear in the moving image. For example, an advertiser who has made a successful bid for the advertising space, which is set for the scene in which a smart phone is used, can make cast members appearing in the moving image use the smart phone to be advertised. Such a method of displaying an advertisement in the main part of the moving image so as to be associated with a specific scene or a cast member is called product placement or the like.

Subsequently, the service providing apparatus 100 presents the plan information received from the content creator CP11 and provides an auction service in which a bid target is the right to display an advertisement in the advertising space that is set to the moving image. At this time, for each advertising space and targeting condition, the service providing apparatus 100 provides the auction service to bid for the right of displaying an advertisement in the advertising space. As described above, the service providing apparatus 100 holds an auction in which the bid target is the right to incorporate an advertisement into a moving image in the stage in which the content creator CP11 plans to create the moving image.

In the case of the example of FIG. 1, the service providing apparatus 100 opens the type, director, actors, and summary of content on the basis of the plan information and provides the auction service related to each advertising space on the basis of the advertising space information. Specifically, the service providing apparatus 100 individually holds auctions for the advertising spaces A, B, and C displayed in the beginning of the moving image and the advertising spaces D and E displayed in the main story of the moving image.

For example, the service providing apparatus 100 holds three auctions relating to the advertising space A. More specifically, the service providing apparatus 100 holds the following auctions: an auction to bid for the right of displaying an advertisement in the advertising space A when the user attribute “sex” of the destination user of content (in practice, composite content to be discussed later) is male; an auction to bid for the right of displaying an advertisement in the advertising space A when the user attribute “sex” of the destination user is female; and an auction to bid for the right of displaying an advertisement in the advertising space A even when the user attribute “sex” of the destination user is either male or female.

Furthermore, as auctions relating to the advertising space B, the service providing apparatus 100 holds an auction to bid for the right of displaying an advertisement in the advertising space B when the user attribute “sex” of the destination user is male; and an auction to bid for the right of displaying an advertisement in the advertising space B when the user attribute “sex” of the destination user is female. Furthermore, since the advertising space C includes no setting of a targeting condition, the service providing apparatus 100 holds an auction to bid for the right of displaying an advertisement in the advertising space C regardless of the user attribute of the destination user. Furthermore, as with the advertising space C, the service providing apparatus 100 holds an auction relating to the advertising spaces D and E.

Subsequently, the service providing apparatus 100 receives bids from the advertisers in each auction (step S12). Then, the service providing apparatus 100 determines the advertiser who bids the highest price to be a winning bidder for the period for which the auction is being held and receives the winning bid amount from the winning bidder (step S13). Then, the service providing apparatus 100 sends the winning bid amount received from the winning bidder to the content creator CP11 (step S14). Although subsequent processes will be described in detail later, the service providing apparatus 100 generates a moving image to be distributed by incorporating advertisement data received from the winning bidder into the moving image created by the content creator after all auctions for respective advertising spaces are successful. In addition, although the advertisement of a different advertiser is displayed on a general web page for each access to the web page, only advertisement data corresponding to the winning bidder is incorporated into each advertising space set for the content such as a moving image according to the embodiment. That is, an advertiser who has become the winning bidder will monopolize the advertising space in which an advertisement is displayed.

As described above, the service providing apparatus 100 according to the first embodiment holds an auction in which the bid target, that is an item to be auctioned off, is the right to display an advertisement for each advertising space and targeting condition which the content creator has set to the content. Thus, the service providing apparatus 100 allows advertisers to bid for the right of displaying an advertisement that is distributed to particular users. For example, some advertisers may desire to distribute an advertisement only to particular users. This will be explained by way of an example. An advertiser who sells goods such as cosmetics or the like that are targeted for females may desire to distribute an advertisement only to females. On the other hand, an advertiser who sells goods such as sporting goods that are targeted for males may desire to distribute an advertisement only to males. Such an advertiser can distribute an advertisement only to particular users by utilizing the service providing apparatus 100 which has been described above. In this respect, the service providing apparatus 100 is capable of providing value-added services to the advertiser.

Furthermore, the content creator who utilizes the aforementioned service providing apparatus 100 can procure more funds when auctions for each advertising space are held for each targeting condition rather than auctions are held for each advertising space. More specifically, since the advertisement is also distributed to unnecessary users when the advertising space includes no setting of a targeting condition, the advertiser who desires to distribute the advertisement to particular users may possibly reduce bid prices. However, since the aforementioned service providing apparatus 100 holds auctions for each targeting condition, thus it is possible to meet the needs of such an advertiser and increase bid prices. Thus, the service providing apparatus 100 allows the content creator to procure more funds. Furthermore, the content creator utilizing the service providing apparatus 100 can obtain winning bid amount for each targeting condition that is set to one advertising space, thus allowing for procuring more funds. In this context, the service providing apparatus 100 can provide value-added services not only to the advertiser but also to the content creator.

### 2. Structure of Service Providing System

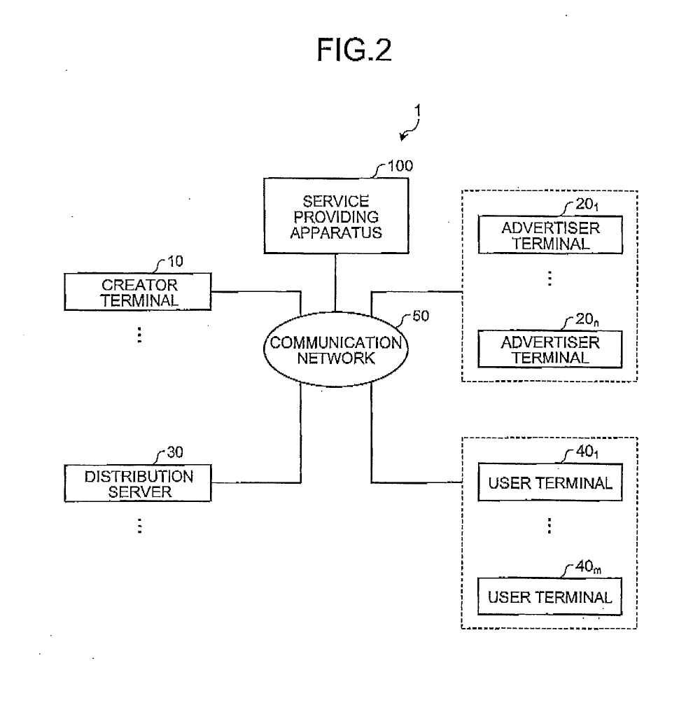

Next, the service providing system according to the first embodiment will be described with reference to FIG. 2. FIG. 2 is a diagram illustrating an example of the structure of the service providing system according to the first embodiment. As illustrated in FIG. 2, a service providing system 1 includes a creator terminal 10, advertiser terminals 20₁ to 20n, a distribution server 30, user terminals 40₁ to 40m, and the service providing apparatus 100. The creator terminal 10, the advertiser terminals 20₁ to 20n, the distribution server 30, the user terminals 40₁ to 40m, and the service providing apparatus 100 are connected through a communication network 50 so as to communicate with each other wirelessly or by wire. In addition, the service providing system 1 illustrated in FIG. 2 may also include a plurality of creator terminals 10, a plurality of distribution servers 30, a plurality of service providing apparatuses 100.

The creator terminal 10 is an information processing apparatus which is used by the content creator. For example, the creator terminal 10 is operated by the content creator to transmit the plan information, the advertising space information, or content, such as a moving image created by the content creator, to the service providing apparatus 100. In the following description, in some cases, the creator terminal 10 is referred to as a content creator. That is, in the following description, the content creator may be replaced with the creator terminal 10.

In some cases, the content creator requests an agent to transmit the plan information. In this case, the agent uses the auction service provided by the service providing apparatus 100. Hereinafter, it is assumed that the term “content creator” includes the agent in addition to the content creator and the term “creator terminal” includes an agent terminal used by the agent in addition to the advertiser terminal.

The advertiser terminals 20₁ to 20ₙ are information processing apparatuses used by advertisers. For example, the advertiser terminals 20₁ to 20ₙ are operated by the advertisers to acquire a web page (hereinafter, may be written as an “auction page”) related to the auction service from the service providing apparatus 100 or to transmit bid information or advertisement data to the service providing apparatus 100. In the following description, in some cases, when it is not necessary to distinguish the advertiser terminals 20₁ to 20ₙ, the advertiser terminals 20₁ to 20ₙ are generically referred to as an “advertiser terminal 20”. In addition, in the following description, in some cases, the advertiser terminal 20 is referred to as an advertiser, a bidder, or a winning bidder. That is, in the following description, the advertiser, the bidder, or the winning bidder may be replaced with the advertiser terminal 20.

In some cases, the advertiser requests the agent to perform a bid operation. In this case, the agent uses the auction service provided by the service providing apparatus 100. In the following description, it is assumed that the term “advertiser” includes the agent in addition to the advertiser and the term “advertiser terminal” includes the agent terminal used by the agent in addition to the advertiser terminal.

The distribution server 30 is, for example, a web server or the like. The distribution server 30 receives distribution target content from the service providing apparatus 100. In addition, the distribution server 30 distributes the content received from the service providing apparatus 100 in response to the requests from the user terminals 40₁ to 40ₘ.

The user terminals 40₁ to 40ₘ are information processing apparatuses used by users who browse content. For example, the user terminals 40₁ to 40ₘ are operated by the users to acquire content, such as a moving image, from the distribution server 30 and to display the acquired content on a display device (for example, liquid crystal display). In the following description, when it is not necessary to distinguish the user terminals 40₁ to 40ₘ, the user terminals 40₁ to 40ₘ are generically referred to as a “user terminal 40”. In the following description, in some cases, the user terminal 40 is referred to as a user or a viewer. That is, in the following description, the user or the viewer may be replaced with the user terminal 40.

The service providing apparatus 100 is, for example, a web server or the like. As described with reference to FIG. 1, the service providing apparatus 100 provides the auction service related to the advertising space which is incorporated into content in the planning stage, or the resale service for reselling the advertising right.

The creator terminal 10, the advertiser terminal 20, or the user terminal 40 is implemented by, for example, a desktop personal computer (PC), a notebook PC, a tablet terminal, a mobile phone, or a personal digital assistant (PDA).

### 3. Structure of Service Providing Apparatus

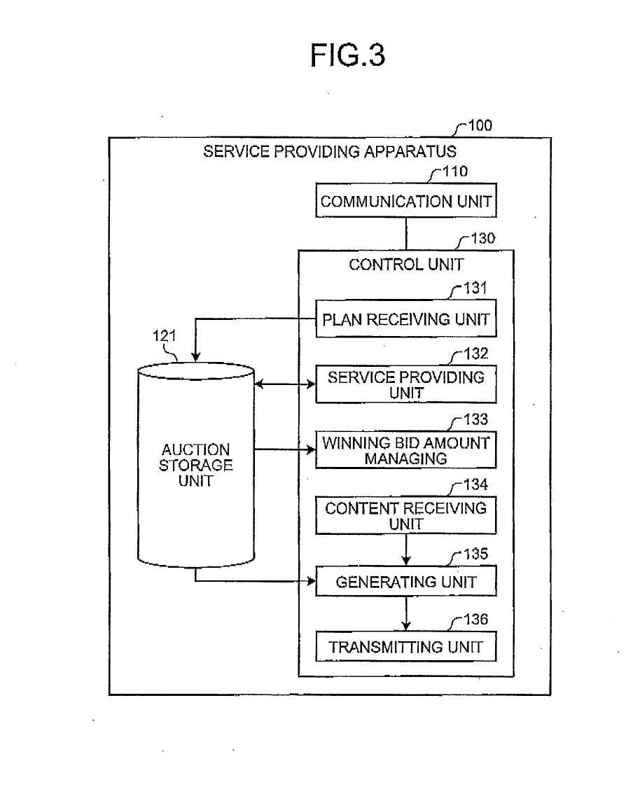

Next, the structure of the service providing apparatus 100 according to the first embodiment will be described with reference to FIG. 3. FIG. 3 is a diagram illustrating an example of the structure of the service providing apparatus 100 according to the first embodiment. As illustrated in FIG. 3, the service providing apparatus 100 includes a communication unit 110, an auction storage unit 121, and a control unit 130. In addition, the service providing apparatus 100 may include an input unit (for example, a keyboard or a mouse) which receives various types of operations from the manager or the like of the service providing apparatus 100 or a display unit (for example, a liquid crystal display) which displays various kinds of information.

The communication unit 110 is implemented by, for example, a network interface card (NIC). The communication unit 110 is connected to the communication network 50 by wire or wirelessly. In addition, the communication unit 110 transmits and receives information to and from the creator terminal 10, the advertiser terminal 20, or the distribution server 30 through the communication network 50.

The auction storage unit 121 is implemented by a semiconductor memory element, such as a random access memory (RAM) or the flash memory, or a storage device, such as a hard disk or the optical disk, for example. The auction storage unit 121 according to the first embodiment stores various kinds of information regarding an auction.

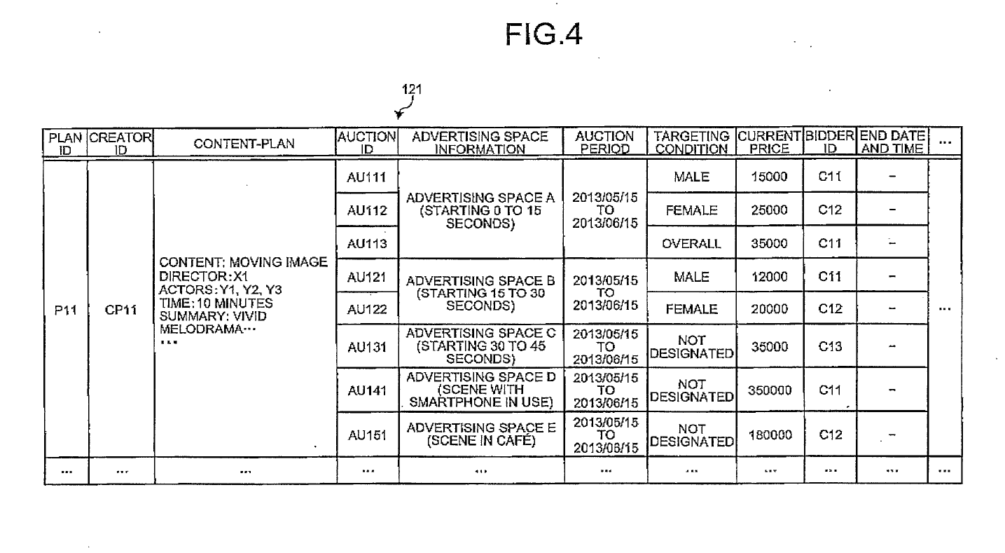

FIG. 4 illustrates an example of the auction storage unit 121 according to the first embodiment. As illustrated in FIG. 4, the auction storage unit 121 has items, such as “plan ID”, “creator ID”, “content-plan”, “auction ID”, “advertising space information”, “an auction period”, “targeting condition”, “current price”, “bidder ID”, and “end date and time”.

The “plan ID” indicates identification information for identifying content which is planned to be created by the content creator. The “content-plan” indicates, for example, skeleton, details or the like of the content. The “creator ID” indicates identification information for identifying the content creator. The “auction ID” indicates identification information for identifying each auction which is held for each advertising space and targeting condition. The “advertising space information” indicates information related to the advertising space incorporated into the content. The “auction period” indicates the period for which the auction is held.

The “targeting condition” is set to the advertising space by the content creator, and indicates, for example, the user attribute of a destination user of the content. The user attribute is, for example, a psychographic attribute or a demographic attribute. The demographic attribute indicates the information of a demographic user attribute. For example, the demographic attribute applies to the user's “address”, “sex”, “age”, “annual income”, “occupation” or “family structure”. On the other hand, the psychographic attribute indicates the user's preference, sense of values, lifestyle, personality or the like. For example, the psychographic attribute applies to the field of user's preferences such as the “car”, “travel”, “clothing”, or “food”.

The “current price” indicates the highest bid price of bid prices offered for the auction at the moment. The “bidder ID” indicates an advertiser ID for identifying the advertiser or the bidder who has bid a highest bid price at the moment. The “end date and time” indicates date and time when the auction has ended.

In addition, in FIG. 4, an auction for which he date and time is not stored in the “end date and time” indicates an auction that is being held or has not been held, and an auction for which the date and time is stored in the “end date and time” indicates an auction that has ended. In addition, when the date and time is stored in the “end date and time”, the current price corresponds to the winning bid price and the bidder applies to the winning bidder. Furthermore, in the example of FIG. 4, it is assumed that the “creator ID” applies to the reference symbol attached to the content creator illustrated in FIG. 1. For example, the creator ID “CP11” indicates the content creator CP11. Furthermore, hereinafter, the information stored in the “bidder ID” illustrated in FIG. 4 may also be used as the reference symbol of an advertiser. For example, the advertiser to be identified by the bidder ID “C11” may also be expressed as the “advertiser C11”.

That is, FIG. 4 illustrates the example in which the content identified by the plan ID “P11” is being planned by the content creator, and the content-plan of the content is, for example, a moving image. Furthermore, FIG. 4 illustrates the example in which five advertising spaces A to E are incorporated into the content. Furthermore, FIG. 4 illustrates the example in which the auction relating to the advertising space A and the targeting condition “male” is identified by the auction ID “A0111”, the auction relating to the advertising space A and the targeting condition “female” is identified by the auction ID “AU112”, and the auction relating to the advertising space A and the targeting condition “overall (none)” is identified by the auction ID “AU113”. Furthermore, FIG. 4 illustrates the example in which eight auctions corresponding to the plan ID “P11” are being held or have not yet been held. As described above, the auction storage unit 121 stores the auction IDs each associated with the advertising spaces that are incorporated into content corresponding to one plan ID (i.e., the content at the planning stage).

In addition, the information stored in the auction storage unit 121 is not limited to the example of FIG. 4. For example, the auction storage unit 121 may store information, such as a “buyout price” which indicates a price at which an object being tendered can be immediately won or the “lowest winning bid price (reserve price)” which indicates the minimum price at which an object being tendered can be won. These “buyout price” and “lowest winning bid price” are included, for example, in the advertising space information to be transmitted from the creator terminal 10 to the service providing apparatus 100, and are set by the content creator. Furthermore, FIG. 4 illustrates the example in which the targeting condition that is set to the advertising space is the sex of the user. However, the service providing apparatus 100 is not limited to this example. For example, as the targeting condition, the advertising space may also store a user attribute such as the user's region of residence, age class, annual income, field of occupation, family structure, or preference.

Referring back to FIG. 3, the control unit 130 is realized, for example, when a central processing unit (CPU) or a micro processing unit (MPU) executes various programs (equivalent to an example of a service providing program), which is stored in a storage device of the service providing apparatus 100, with the RAM as a work area. In addition, the control unit 130 is realized by an integrated circuit, such as an application specific integrated circuit (ASIC) or a field programmable gate array (FPGA), for example.

As illustrated in FIG. 3, the control unit 130 includes a plan receiving unit 131, a service providing unit 132, a winning bid amount managing unit 133, a content receiving unit 134, a generating unit 135, and a transmitting unit 136, and performs or implements the following information processing function or operation. In addition, the internal structure of the control unit 130 is not limited to that illustrated in FIG. 3, but the control unit 130 may have any structure as long as it can perform the following information processing. In addition, the connection relation between the processing units of the control unit 130 is not limited to that illustrated in FIG. 3, but other connection relations may be established between the processing units.

The plan receiving unit 131 receives the plan information and the advertising space information from the content creator (for example, the creator terminal 10) who plans to create content. Specifically, the plan receiving unit 131 receives, from the content creator, the plan information indicating the content-plan. Furthermore, the plan receiving unit 131 receives the advertising space information relating to the advertising space which is set to the content by the content creator and which is related to the targeting condition that is set to the advertising space by the content creator. Then, when the plan information and the advertising space information are received, the plan receiving unit 131 assigns a new plan ID and also assigns an auction ID for each advertising space and targeting condition. Then, the plan receiving unit 131 stores the plan information in the “content-plan” of the auction unit 121 so as to be associated with the new plan ID. In addition, the plan receiving unit 131 stores the auction ID for each advertising space in the auction storage unit 121 so as to be associated with the plan ID and stores the advertising space information and the targeting condition in the auction storage unit 121 so as to be associated with each auction ID. At this time, the plan receiving unit 131 also stores, in the auction storage unit 121, the creator ID corresponding to the content creator that is the sender of the plan information and the advertising space information. For example, The creator ID is transmitted together with the plan information and the advertising space information by the content creator. Alternatively, when login is required to use various services provided by the service providing apparatus 100, the login ID or the like of the content creator may be the creator ID.

In addition, the plan receiving unit 131 analyzes, for example, the plan information to extract information corresponding to each item, such as the type, director, and an actors of the content. For example, when the plan information is described by a markup language, such as XML (Extensible Markup Language), the plan receiving unit 131 can easily extract the information corresponding to each item from the plan information. In addition, when the format of the plan information is determined in advance, the plan receiving unit 131 can easily extract various kinds of information from the plan information based on the format determined in advance. Similarly, when the advertising space information is described by a markup language or when the format of the advertising space information is determined in advance, the plan receiving unit 131 can easily extract various kinds of information from the advertising space information.

In addition, the plan receiving unit 131 may receive advertising space information including the auction period set by the content creator. At this time, the plan receiving unit 131 may also receive the auction period for each advertising space or may also receive the auction period for each advertising space and targeting condition. In this case, the plan receiving unit 131 stores the auction period, which is included in the advertising space information, in the auction storage unit 121. However, the plan receiving unit 131 may store the auction period, which is determined in advance, in the auction storage unit 121 without being limited to this example. For example, the plan receiving unit 131 may set, as the auction period, a period until predetermined days pass from the date and time when the advertising space information is received.

In addition, the plan receiving unit 131 may also provide the content creator with a submission site for inputting the plan information or the advertising space information. For example, the plan receiving unit 131 provides a submission site for inputting the type, content-plan, or the like of the content. In addition, for example, the plan receiving unit 131 provides a submission site for inputting the temporal position where an advertising space is reproduced (hereafter, may be written as a reproduction position), reproduction time of the advertising space, display size of the advertising space, the targeting condition or the like. In this case, the plan receiving unit 131 receives various kinds of information input to the submission site as plan information and advertising space information.

The service providing unit 132 provides an auction service to bid for the right of displaying an advertisement in the advertising space for each targeting condition on the basis of the advertising space information received by the plan receiving unit 131.

Specifically, when a request for au auction page is received from the advertiser terminal 20, the service providing unit 132 provides the auction page to the advertiser terminal 20. In this case, the service providing unit 132 provides an auction page including the content-plan and information about the auction related to each advertising space, on the basis of the plan information and the advertising space information received from the content creator.

As an example, the service providing unit 132 transmits a list of the content-plan stored in the auction storage unit 121 to the advertiser terminal 20. Then, the service providing unit 132 receives an acquisition request including a plan ID which corresponds to the content-plan selected from the list, from the advertiser terminal 20. In this case, the service providing unit 132 acquires various kinds of information corresponding to the plan ID, which is included in the acquisition request, from the auction storage unit 121. In the example of FIG. 4, the service providing unit 132 acquires, from the auction storage unit 121, the content-plan and the auction period corresponding to the plan ID, and the advertising space information, the targeting condition, the current price, the bidder ID, the end date and time, and the like for each auction ID corresponding to the plan ID. Then, the service providing unit 132 generates an auction page, on which content-plan and the like are published, using the acquired various kinds of information, and provides the generated auction page to the advertiser terminal 20.

In addition, the service providing unit 132 receives the bid information including the bid price from the advertiser terminal 20 through the auction page. In this case, the service providing unit 132 stores the bid price included in the bid information in the auction storage unit 121 so as to be associated with the auction ID indicating the auction for which a bid is to be made. In this case, the service providing unit 132 also stores the bidder ID corresponding to the bidder, who is the transmission source of the bid information, in the auction storage unit 121. In addition, the service providing unit 132 may receive the bidder ID together with the bid information, or may consider the login ID or the like of the bidder as the bidder ID. In addition, when an auction is successful, the service providing unit 132 stores the date and time of the auction in the end date and time of the auction storage unit 121, and stores an advertiser ID for identifying the winning bidder in the bidder ID of the auction storage unit 121.

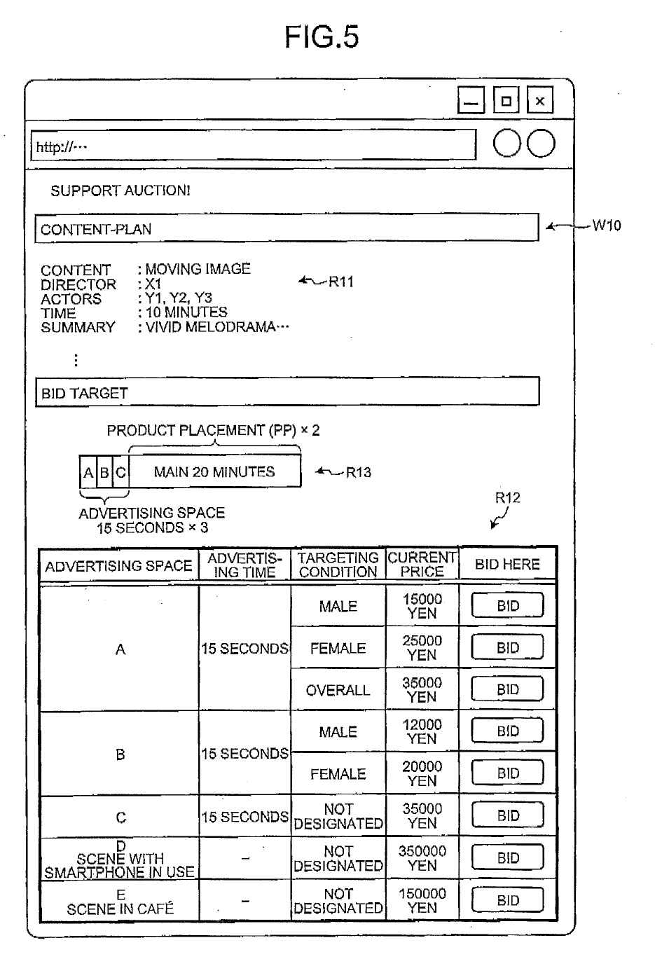

Here, FIG. 5 illustrates aft example of auction pages generated by the service providing unit 132 according to the first embodiment. FIG. 5 illustrates an example of an auction page W10 corresponding to the plan ID “P11” illustrated in FIG. 4. As in the example illustrated in FIG. 5, the service providing unit 132 inserts the content-plan stored in the auction storage unit 121 into a plan display field R11 of the auction page W10. In addition, the service providing unit 132 inserts, for example, the advertising space information and the targeting condition and the like for each auction ID, which are stored in the auction storage unit 121 so as to be associated with the plan ID “P11” into a bid display field R12 of the auction page W10. In addition, the service providing unit 132 inserts an image diagram in which the reproduction position of the advertising space is visible into an image display field R13 of the auction page W10. Thus, when the advertising space information includes information regarding a plurality of advertising spaces, the service providing unit 132 inserts all pieces of the advertising space information into the auction page W10 and individually holds the auctions related to each advertising space.

In addition, although not illustrated in the drawings, when a bid button displayed in the bid display field R12 is pressed, the service providing unit 132 provides a bid page for inputting the bid price to the advertiser terminal 20. Then, the service providing unit 132 receives bid information including the bid price from the advertiser terminal 20 through the bid page.

In addition, the auction page W10 is not limited to that illustrated in FIG. 5. For example, the service providing unit 132 may insert the name or the like of the content creator into the plan display field R11. In addition, for example, the service providing unit 132 may display information (for example, the company name or the type of industry) regarding a bidder who has bid the highest price. In addition, for example, the content creator may set the target price of the reserve price as an estimated price required to create content to the plan information. In this case, the service providing unit 132 may insert the target price of the winning bid price into the plan display field R11. In addition, for example, the service providing unit 132 may insert the holding period of the auction in the bid display field R12. In addition, for example, the service providing unit 132 may not insert the image diagram into the image display field R13.

Then, the service providing unit 132 assumes that, when all auctions for respective advertising spaces have ended, all of the auctions are successful formally. Specifically, the service providing unit 132 assumes that, even if some of the auctions for respective advertising spaces have ended, some of the auctions are temporarily successful until all auctions are successful. In the example illustrated in FIG. 5, the service providing unit 132 holds eight auctions for advertising spaces A to E. Here, when the holding period of each auction is different or when a buyout price is set for each auction, the eight auctions do not necessarily end simultaneously. For example, it is assumed that only the auction for the advertising space A and the targeting condition “male” has ended among the eight auctions. In this case, the service providing unit 132 assumes that until all the eight auctions are successful, the auction relating to the advertising space A and the targeting condition “male” has been temporarily successful and the winning bidder has been temporarily determined. Then, after all the eight auctions are ended, the service providing unit 132 finalizes the winning bidder of each auction assuming that all the auctions have been officially successful. That is, the service providing unit 132 stores an end date and time in the auction storage unit 121 each time the winning bidder is determined and the auction is ended, and assumes that all the auctions have been officially successful when of a plurality of auction IDs associated with one plan ID, the end dates and times corresponding to all the auction IDs have been stored.

Here, when some of the plurality of auctions are not successful, the service providing unit 132 may assume that no auctions have been successful. As a state where an auction is not successful, a case where there is no bid, a case where the highest bid price does not reach the minimum bid price, and the like can be mentioned. In this case, the service providing unit 132 may hold all auctions again. Alternatively, the service providing unit 132 may hold again only some auctions that have not been successful. In addition, the service providing unit 132 may also hold again each auction relating to the advertising space corresponding to some of the auctions that have not been successful. For example, in the example of FIG. 5, suppose that the auctions relating to the advertising space A and the targeting condition “male” have not been successful. In this case, the service providing unit 132 may also hold again the three auctions relating to the advertising space A. Note that the service providing unit 132 may also set the lowest winning bid price, which is lower than the lowest winning bid price previously employed, to the auction to be held again. Furthermore, when some of a plurality of auctions have not been successful, the service providing unit 132 may also inform the content creator of this fact. Then, the service providing unit 132 may also follow an instruction from the content creator to determine whether to hold again all the auctions or hold again only some of the auctions that have not been successful.

Now, a description will be made to the process for determining a winning bidder by the service providing unit 132. First, for an auction relating to an advertising space including no setting of a targeting condition or for an auction relating to an advertising space including no setting of overlapping targeting conditions, the service providing unit 132 determines that the advertiser who has put in the highest bid is accepted as a winning bidder. For example, the targeting conditions “male” and “female” which are set at the advertising space B illustrated in FIG. 5 do not overlap each other. In this case, the service providing unit 132 determines that an advertiser who put in the highest bid for the auction relating to the targeting condition “male” of the advertising space B is accepted as the winning bidder, while an advertiser who put in the highest bid for the auction relating to the targeting condition “female” of the advertising space B is accepted as the winning bidder. Furthermore, since no targeting condition is set at the advertising space C illustrated in FIG. 5, the service providing unit 132 holds one auction relating to the advertising space C. In this case, the service providing unit 132 determines that an advertiser who put in the highest bid for the auction relating to the advertising space C is accepted as the winning bidder.

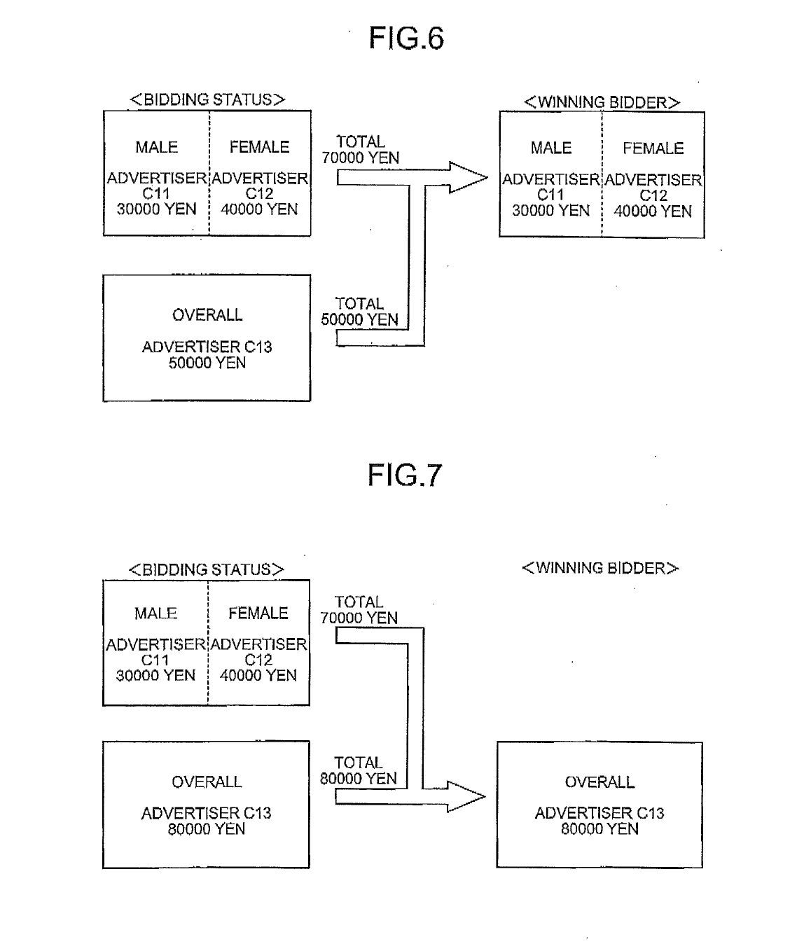

On the other hand, when some of a plurality of targeting conditions having been set to the advertising space overlap each other, the service providing unit 132 gets, among a plurality of auctions corresponding to such multiple targeting conditions, a combination of auctions done, the combination of auctions in which mutual targeting conditions do not overlap and the total winning bid price is maximized. Referring to the examples of FIGS. 6 and 7, this point will be explained. FIGS. 6 and 7 are views illustrating an example of a winning bidder determination process followed by the service providing unit 132 according to the first embodiment. Note that in relation to FIGS. 6 and 7, a description will be made, by way of example, to an auction relating to the advertising space A illustrated in FIG. 5.

In FIG. 6, it is assumed that the advertiser C11 tendered a winning bid price of “30000 yen” in the auction corresponding to the targeting condition “male” among each auctions relating to the advertising space A, an advertiser C12 tendered a winning bid price of “40000 yen” in the auction corresponding to the targeting condition “female”, and an advertiser C13 tendered a winning bid price of “50000 yen” in the auction corresponding to the targeting condition “overall (none)”.

Here, the targeting conditions “male” and “overall” partially overlap each other. More specifically, a user who is a male applies to some of all users including male and female users. Likewise, the targeting conditions “female” and “overall” partially overlap each other. On the other hand, the targeting conditions “male” and “female” do not overlap each other. In such a case, the service providing unit 132 makes a comparison between the total amount of winning bid prices for auctions corresponding to the targeting conditions that do not overlap each other and a winning bid price for an auction corresponding to a targeting condition that overlaps another targeting condition, and determines that an advertiser who tendered the higher winning bid price is accepted as the winning bidder.

In the case of the example of FIG. 6, the service providing unit 132 computes the total amount “70000 yen” of a winning bid price “30000 yen” for the targeting condition “male” and a winning bid price “40000 yen” for the targeting condition “female”, the targeting conditions not overlapping each other. Then, since the total amount of “70000 yen” is higher than the winning bid price “50000 yen” for the auction corresponding to the targeting condition “overall”, the service providing unit 132 determines that the advertisers C11 and C12 are accepted as the winning bidders.

On the other hand, in the example illustrated in FIG. 7, suppose that the advertiser C13 tendered a winning bid price “80000 yen” in the auction corresponding to the targeting condition “overall (none)”. In this case, the service providing unit 132 determines that the advertiser C13 is accepted as the winning bidder because the winning bid price “80000 yen” of the advertiser C13 is higher than the aforementioned total amount “70000 yen”.

In this manner, when targeting conditions overlap each other, the service providing unit 132 determines the winning bidder on the basis of the winning bid prices so that the targeting conditions do not overlap each other. Thus, the service providing unit 132 allows the advertiser, who is the winning bidder, to have the exclusive right of displaying the advertisement as well as the content creator to procure more funds. Note that the aforementioned combined auction into which a plurality of auctions have been combined is designed, for example, by mechanism design.

Referring back to the description of FIG. 3, the winning bid amount managing unit 133 manages the winning bid amount received from the winning bidder who has successfully bid the right. Specifically, even when the winning bid amount is received from the winning bidder, the winning bid amount managing unit 133 instantly stores the entire winning bid amount, without sending the winning bid amount to the content creator. Whenever the content creator charges for the creation of content, the winning bid amount managing unit 133 sends the amount of money corresponding to the charge from the stored reserve price to the content creator. For example, the winning bid amount managing unit 133 receives, from the creator terminal 10, charge data, such as clothing expenses, filming expenses, or food expenses which have been actually used to create content, or food expenses which will be used to create content immediately. Then, the winning bid amount managing unit 133 sends the amount of money corresponding to the received charge data to the content creator. In addition, the winning bid amount managing unit 133 manages winning bid amount using the current price (that is, the highest bid price) stored in the auction storage unit 121.

Thus, the winning bid amount managing unit 133 does not instantly send the winning bid amount received from the winning bidder to the content creator, but gradually sends the winning bid amount in response to the request from the content creator. Therefore, the winning bid amount managing unit 133 can prevent the winning bid amount from being sent to the content creator who does not create content. As a result, the winning bid amount managing unit 133 can prevent the abuse of the auction service provided by the service providing apparatus 100.

In addition, when the total amount of money charged by the content creator is less than the winning bid amount, the winning bid amount managed by the winning bid amount managing unit 133 is left over. In this case, the winning bid amount managing unit 133 may send the surplus money to the content creator after the content creator has created the content. Accordingly, since the winning bid amount managing unit 133 pays the content creator compensation for the completion of the content, it is possible to improve the creative impulse of the content creator.

In addition, although the example where the winning bid amount managing unit 133 transfers winning bid amount to the content creator is illustrated in the example described above, the winning bid amount managing unit 133 may perform only processing for calculating the amount of money transferred to the content creator. Then, the administrator or the like of the service providing apparatus 100 may transfer to the content creator the amount of money calculated by the winning bid amount managing unit 133.

The content receiving unit 134 receives the content corresponding to the plan information from the content creator (for example, the creator terminal 10). For example, when the content creator which has transmitted the plan information completes content, the content receiving unit 134 receives a completed content. In addition, the content receiving unit 134 receives advertisement data which is incorporated into the advertising space from the winning bidder (for example, the advertiser terminal 20).

Note that the winning bidder having the right of displaying an advertisement may transfer this right to another advertiser. In this case, the content receiving unit 134 receives advertisement data not only from the winning bidder but also from an advertiser who has the right of displaying an advertisement. Hereinafter, it is assumed that even when simply expressed as “the winning bidder”, the winning bidder can also include the advertiser to whom the right of displaying an advertisement has been transferred.

The generating unit 135 combines the content and the advertisement data received from the content receiving unit 134 to generate composite content. Specifically, the generating unit 135 generates composite content after all auctions corresponding to the predetermined plan information (plan ID) are successful in the auction service provided by the service providing unit 132. In this case, the generating unit 135 generates composite content by incorporating the advertisement data of the advertiser, who has made a successful bid for the right to display an advertisement in an advertising space set to the content created by the content creator, in the advertising space based on the advertising space information stored in the auction storage unit 121.

In addition, as described above, the advertising space for which the advertiser has made a successful bid may correspond to a cast frame in which an advertising product appears in an image, as in the product placement. In this case, for example, the content creator receives an advertising product from the advertiser, who is a winning bidder, and creates the content, such as a moving image, using the received advertising product. Therefore, when the advertising space is the product placement, the content creator creates composite content including the advertisement data. That is, the content received by the content receiving unit 134 may correspond to composite content. For this reason, the generating unit 135 does not perform the process of generating the composite content when the advertising space set to the content is only the product placement. In other words, the generating unit 135 performs the above process of generating the composite content when advertising spaces that can be incorporated into the finished product of the content, such as the advertising spaces A to C illustrated in FIG. 1 and the like, are set to the content.

The transmitting unit 136 transmits the composite content generated by the generating unit 135 or the composite content received by the content receiving unit 134 to the distribution server 30. As a result, the distribution server 30 distributes the composite content, in which the advertisement data is incorporated, to the user terminal 40 in response to a request from the user terminal 40.

Here, referring to the example of FIG. 6, a description will be made to the processing of the generating unit 135 and the transmitting unit 136. In FIG. 6, the service providing unit 132 determines the winning bidder, who won the right of displaying an advertisement in the advertising spice A, as the advertisers C11 and C12. In this case, the generating unit 135 generates the composite content with the advertisement data of the advertiser C11 incorporated in the advertising space A and the composite content with the advertisement data of the advertiser C12 incorporated in the advertising space A. Then, the transmitting unit 136 transmits the combination of the composite content generated by the generating unit 135 and the targeting condition to the distribution server 30. This allows the distribution server 30 to distribute, to the user terminal 40, the composite content with the user attribute of the destination user coincident with the targeting condition. For example, the distribution server 30 distributes the composite content with the advertisement data of the advertiser C11 incorporated therein when the destination user is male, and distributes the composite content with the advertisement data of the advertiser C12 incorporated therein when the destination user is female. Note that the distribution server 30 retains the user attribute for each user (such as the psychographic attribute and the demographic attribute). For example, the user attribute is set by the user as profile information. Or alternatively, the user attribute 18 estimated, for example, by the distribution server 30 from the view history of the content (such as web pages) viewed by the user or search keywords entered by the user on web pages to be searched.

### 4. Service Providing Procedure

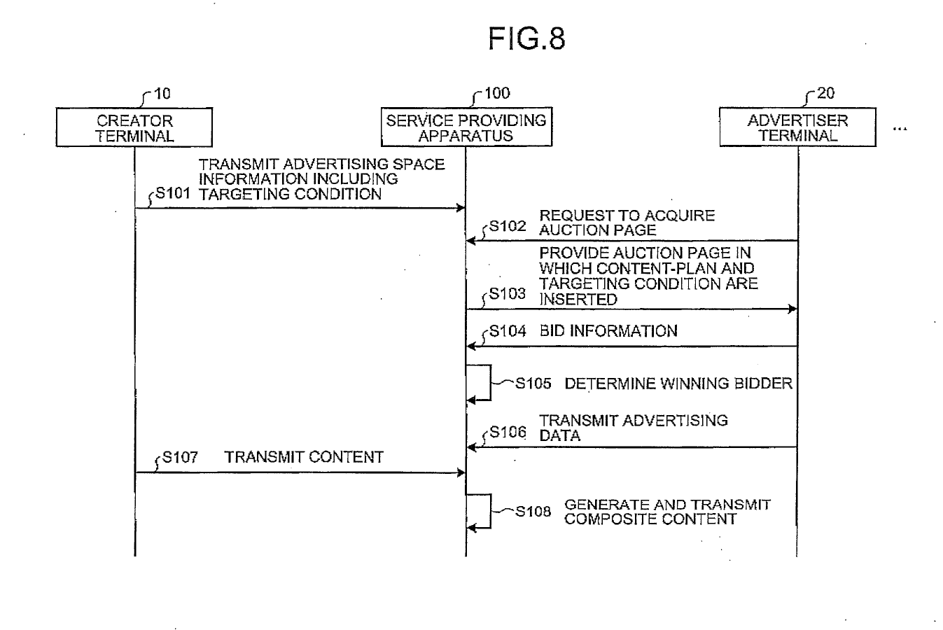

Next, the procedure of the service providing process of the service providing system 1 according to the first embodiment will be described with reference to FIG. 8. FIG. 8 is a sequence diagram illustrating the service providing procedure of the service providing system 1 according to the first embodiment. Note that although FIG. 8 illustrates only one advertiser terminal 20. However, in practice, there exist a plurality of advertiser terminals 20.

As illustrated in FIG. 8, the content creator transmits the plan information and the advertising space information including targeting conditions to the service providing apparatus 100 using the creator to urinal 10 (step S101). In this case, the service providing apparatus 100 stores the plan information and the advertising space information in the auction storage unit 121.

In addition, in the example of FIG. 8, an example is illustrated in which the content creator transmits the plan information and the advertising space information at the same time. However, the content creator may transmit the plan information and the advertising space information at different times. For example, the content creator may transmit the advertising space information to the service providing apparatus 100 after transmitting the plan information. In addition, for example, the content creator may input various kinds of information to the submission site described above to transmit the plan information and the advertising space information to the service providing apparatus 100. In this case, the content creator may input the plan information to the submission site first, and input the advertising space information to the submission site in another day or the like.

Subsequently, the service providing apparatus 100 receives a request for an auction page from the advertiser terminal 20 (step S102). In this case, the service providing apparatus 100 provides the auction page having the content-plan and the targeting condition of content inserted thereinto to the advertiser terminal 20 (step S103). Then, the service providing apparatus 100 receives bid information including the bid price from the advertiser terminal 20 through the auction page (step S104). Thus, the service providing apparatus 100 receives bid information from a plurality of advertiser terminals 20.

Then, the service providing apparatus 100 determines a winning bidder on the basis of the bid information received from the advertiser terminal 20 (step S105). For example, the service providing apparatus 100 determines an advertiser who has bid the highest price at the end date and time when the auction period is expired, as a winning bidder. Furthermore, for example, when the targeting conditions overlap each other as in the example illustrated in FIG. 6 and FIG. 7, the service providing apparatus 100 determines the winning bidder so that the targeting conditions do not overlap each other. Then, the service providing apparatus 100 puts under control the winning bid amount sent by the winning bidder. After this, when charged by the content creator for the production costs, the service providing apparatus 100 remits, to the content creator, the amount of charge from the winning bid amount.

Furthermore, the winning bidder transmits advertisement data to the service providing apparatus 100 using the advertiser terminal 20 (step S106). Then, when the content has been created content, the content creator transmits the content to the service providing apparatus 100 using the creator terminal 10 (step S107).

Then, the service providing apparatus 100 incorporates the advertisement data received from the advertiser into the content received from the content creator to generate composite content and transmits the generated composite content to the distribution server 30 (step S108).

### 5. Effects

As described above, the service providing apparatus 100 according to the first embodiment has the plan receiving unit 131 and the service providing unit 132. The plan receiving unit 131 receives the advertising space information which relates to the advertising space that is set to the content by the content creator who creates the content and which relates to the targeting condition that is set by the content creator to the advertising space. The service providing unit 132 provides an auction service to bid for the right of displaying an advertisement in an advertising space for each targeting condition on the basis of the advertising space information received by the plan receiving unit 131.

Thus, the service providing apparatus 100 according to the first embodiment allows an advertiser to bid for the right of displaying an advertisement, which is to be distributed to a particular target, and thus can provide a value-added service to the advertiser.

Furthermore, in the service providing apparatus 100 according to the first embodiment, when some of a plurality of targeting conditions set at the advertising space overlap each other, the service providing unit 132 establishes a combination of a plurality of auctions corresponding to the plurality of targeting conditions, the combination of the auctions having targeting conditions that do not overlap each other and providing the maximum total winning bid price.

Thus, the service providing apparatus 100 according to the first embodiment enables the advertiser or the winning bidder to have an exclusive right of displaying the advertisement as well as the content creator to procure more funds.

### Second Embodiment

A second embodiment will illustrate an example of providing an auction service for predicting, for each targeting condition, the number of times the content to be planned are viewed by users and than presenting the prediction result to the advertiser who is the bidder. Note that hereinafter, the number of times by which content is viewed by users may be written as “the number of PV (page view)” below. In addition, hereinafter, the predicted value of the number of PV may be written as “the predicted number of PV” below.

### 1. Structure of Service Providing Apparatus

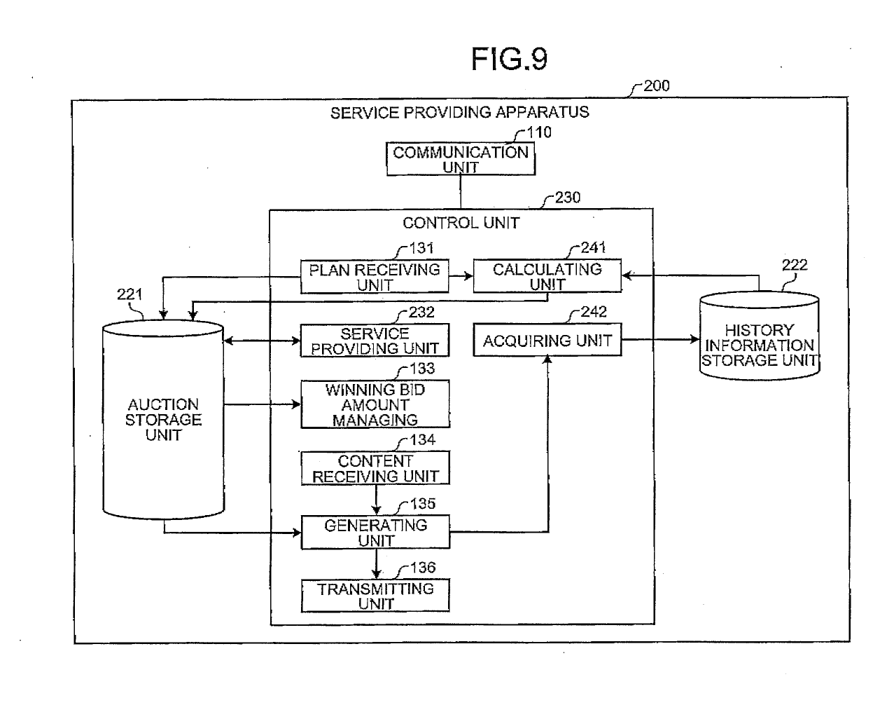

First, referring to FIG. 9, a description will be made to the structure of a service providing apparatus 200 according to the second embodiment. FIG. 9 is a diagram illustrating an example of the structure of the service providing apparatus 200 according to the second embodiment. As illustrated in FIG. 9, the service providing apparatus 200 has an auction storage unit 221, a history information storage unit 222, and a control unit 230.

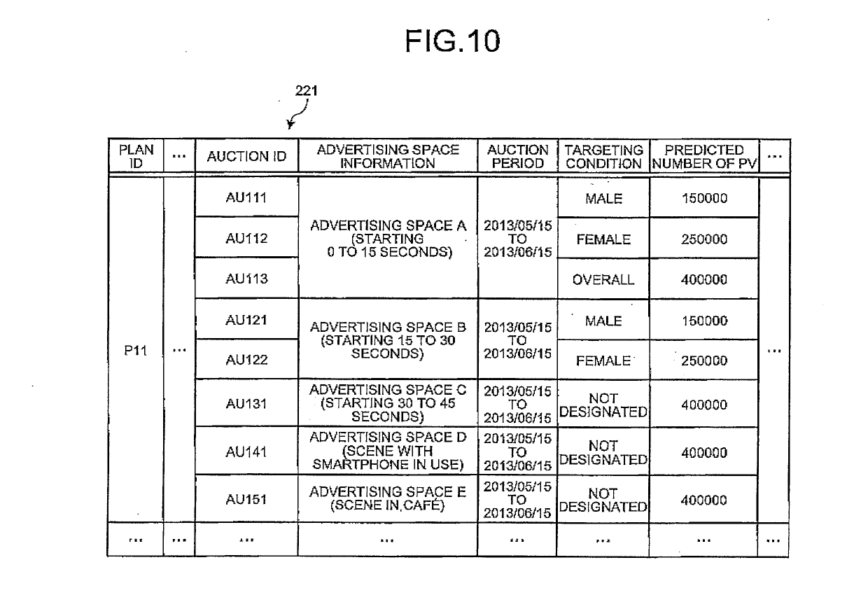

FIG. 10 illustrates an example of the auction storage unit 221 according to the second embodiment. As illustrated in FIG. 10, the auction storage unit 221 stores information such as “predicted number of PV”. Note that although not illustrated in FIG. 10, the auction storage unit 221 also stores “content-plan”, “current price”, “bidder ID”, and “end date and time”, which are illustrated in FIG. 4.

The “predicted number of PV” indicates the prediction value of the number of times the completed version, of the content that are planning to be created by the content creator is viewed by users. In other words, “the predicted number of PV” indicated in FIG. 10 illustrates, to users who are determined on the basis of the targeting condition, the prediction value of the number of times the completed version of the content is viewed by the users. The “predicted number of PV” is calculated by a calculating unit 241 to be discussed later.

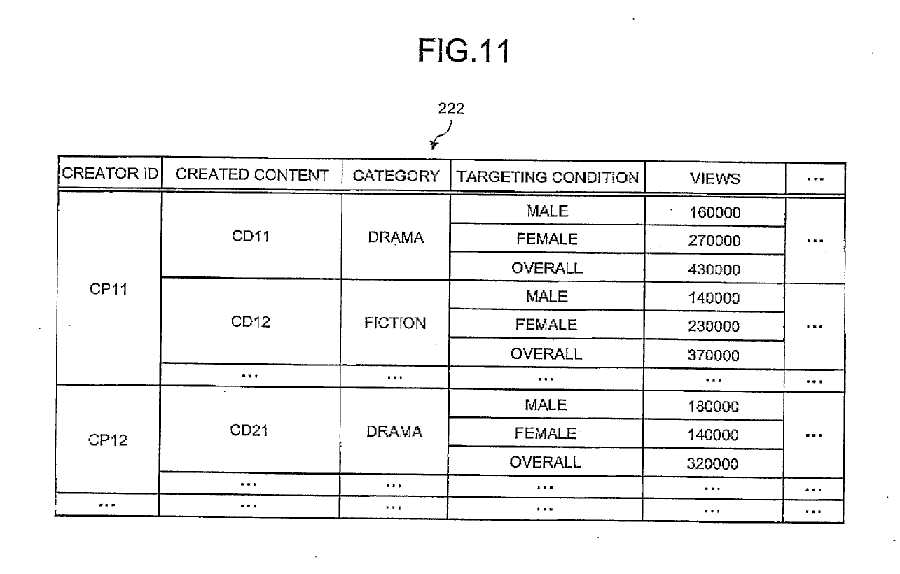

FIG. 11 illustrates an example of the history information storage unit 222 according to the second embodiment. As illustrated in FIG. 11, the history information storage unit 222 has items such as “creator ID”, “created content”, “category”, “targeting condition”, and “views”.

The “creator ID” indicates identifying information for identifying the content creator. The “created content” indicates content created in the past by the content creator. FIG. 11 illustrates an example is illustrated in which conceptual information, such as a “CD11”, is stored in “created content”. In practice, however, content, such as a moving image, or a file path name indicating the Storage location of the content or the like is stored.

The “category” indicates the category to which the created content belongs. Example categories of created content may include the drama, the fiction, and the animation. Note that the category of content is included, for example, in the plan information and set by the content creator. However, the category of content may also be set by the manager or the like of the service providing apparatus 200 or the distribution server 30 who checked the content that was completed. The “targeting condition” indicates the targeting condition that was used by the distribution server 30 to determine the destination user of the created content. That is the “targeting condition” indicates the user attribute of the user to whom the distribution server 30 actually distributed the created content. The “views” indicates the number of times the content has been viewed. In other words, the “views” indicates the number of times the distribution server 30 has distributed the content (in practice, the composite content to be discussed later) to the user terminal 40.

That is, FIG. 11 illustrates the example in which the content creator CP11 created the content “CD11” or “CD12” in the past. Furthermore, FIG. 11 illustrates the example in which the content “CD11” is content relating to a drama (for example, moving image). Furthermore, FIG. 11 illustrates the example in which the content “CD11” are viewed 160000 times by users with the user attribute “male”; viewed 270000 times by users of the user attribute “female”; and thus viewed 430000 times in total.

Referring back to the description of FIG. 9, the control unit 230 has the calculating unit 241, an acquiring unit 242, and a service providing unit 232. The calculating unit 241 calculates the predicted number of PV that is a prediction value of the number of times the content being planned are viewed by users. More specifically, when the plan receiving unit 131 has received the plan information and the advertising space information, the calculating unit 241 calculates the predicted number of PV, for each targeting condition included in the advertising space information, on the basis of various types of information stored in the history information storage unit 222. Then, the calculating unit 241 stores the calculated predicted number of PV in the auction storage unit 221.

As an aspect, on the basis of the views of content created in the past by the content creator who transmitted the plan information, the calculating unit 241 calculates a predicted number of PV of the content corresponding to the plan information. More specifically, of the created content stored in the history information storage unit 222, the calculating unit 241 identifies the created content corresponding to the creator ID of the content creator who transmitted the plan information. Then, on the basis of the views, for each targeting condition, corresponding to the identified created content, the calculating unit 241 calculates the predicted number of PV for each targeting condition of the content being planned. For example, as the predicted number of PV, the calculating unit 241 calculates the average value of the views corresponding to the created content. This is because the number of PVs of content created by the same content creator is thought to lie within a certain range.

Now, referring to the example of FIG. 11, a description will be made to the aforementioned computation process. Here, it is assumed that the content creator CP11 has transmitted the plan information. In this case, the calculating unit 241 identifies the created content “CD11” and “CD12” with the creator ID being the “CP11”. Then, the calculating unit 241 calculates the average value “150000” between the views “160000” corresponding to the created content “CD11” and the targeting condition “male” and the views “140000” corresponding to the created content “CD12” and the targeting condition “male”. Then, the calculating unit 241 employs the calculated average value “150000” as the predicted number of PV corresponding to the user attribute “male” of the content corresponding to the plan information. That is, the calculating unit 241 predicts that the content being planned by the content creator CP11 will be viewed “150000” times by users of the user attribute “male”. Note that the calculating unit 241 may also calculate, as the predicted number of PV, a value obtained by subtracting an amount of a predetermined percentage from the average value “150000”. In the same manner, the calculating unit 241 calculates the predicted number of PV “250000” corresponding to the user attribute “male” of the content corresponding to the plan information and calculates the predicted number of PV “400000” corresponding to the user attribute “overall”.

Furthermore, as another aspect, the calculating unit 241 according to the embodiment calculates the predicted number of PV on the basis of the views of the created content corresponding to the plan information received by the plan receiving unit 131 among all the created content stored in the history information storage unit 222 (i.e., the created content that is created in the past not only by the content creator, who transmitted the plan information, but also by various content creators). More specifically, the calculating unit 241 identifies the created content of which category coincides with that of the content included in the plan information, and calculates the predicted number of PV on the basis of the views corresponding to the identified created content. This is because the number of PVs of those content of the same category may often fall in a certain range. For example, it is thought to be true that content relating to the drama tend to be typically viewed 100000 times, while content relating to the animation tend to be viewed typically 50000 times.

Referring to the example of FIG. 11, a description will be made to the aforementioned computation process. Here, it is assumed that the content included in the plan information have the category “drama”. In this case, the calculating unit 241 identifies the created content “CD11” and “CD21” that have the category “drama”. Then, the calculating unit 241 calculates the average value “170000” between the views “160000” corresponding to the created content “CD11” and the targeting condition “male” and the views “180000” corresponding to the created content “CD21” and the targeting condition “male”. Then, the calculating unit 241 employs the calculated average value “170000” as the predicted number of PV corresponding to the user attribute “male” of the content corresponding to the plan information.

The acquiring unit 242 acquires various types of information to be used to calculate the predicted number of PV of content. More specifically, the acquiring unit 242 associates the composite content generated by the generating unit 135 with the creator ID of the content creator so as to be stored in the created content of the history information storage unit 222. That is, the acquiring unit 242 stores the composite content generated by the generating unit 135 in the history information storage unit 222 as the content created in the past by the content creator. However, the invention is not limited to this example, and the acquiring unit 242 may also store content received by the content receiving unit 134 in the created content of the history information storage unit 222.

Furthermore, the acquiring unit 242 periodically accesses the distribution server 30 to thereby acquire, from the distribution server 30, the number of distributions for each targeting condition of the composite content. Then, the acquiring unit 242 associates the number of distributions for each targeting condition with the composite content (the created content) so as to be stored in the views of the history information storage unit 222.

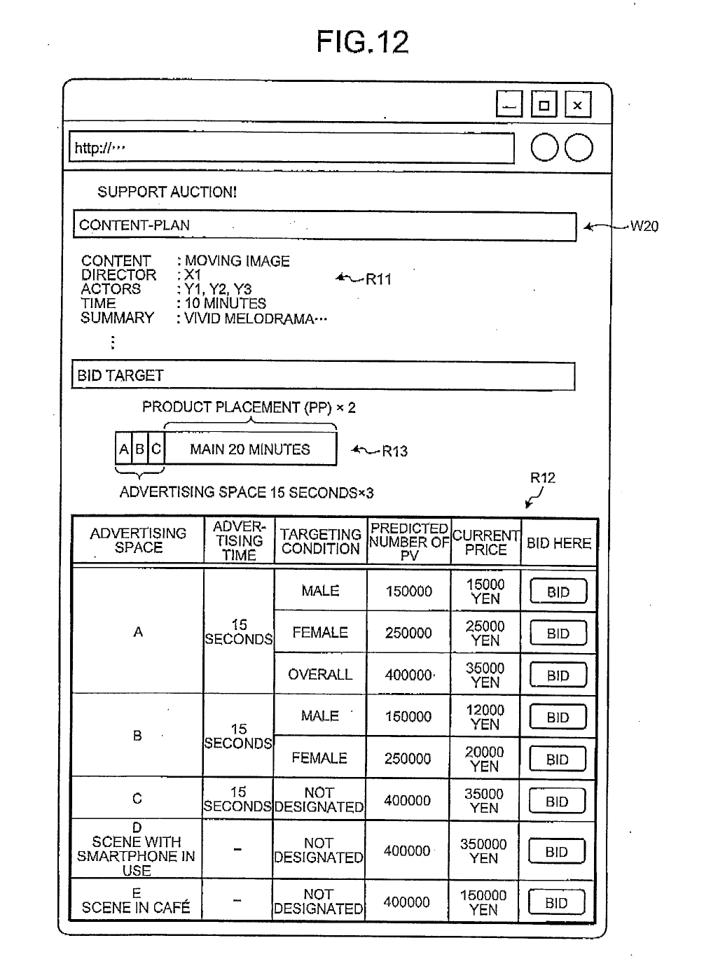

The service providing unit 232 presents the predicted number of PV calculated by the calculating unit 241 as well as provides an auction service. More specifically, the service providing unit 232 provides an auction page on which the predicted number of PV stored in the auction storage unit 221 is publicized. Here, FIG. 12 is a diagram illustrating an example of an auction page which is created by the service providing unit 232 according to the second embodiment. As with the example illustrated in FIG. 12, the service providing unit 232 publicizes the predicted number of PV for each targeting condition in the bid display field R12 of an auction page W20.

### 2. Effects

As described above, the service providing apparatus 200 according to the second embodiment has the calculating unit 241 and the service providing unit 232. When the plan receiving unit 131 has received the plan information, the calculating unit 241 calculates, on the basis of the plan information, the predicted number of PV which is a prediction value of the number of times the content corresponding to the plan information are viewed by users. The service providing unit 232 presents the predicted number of PV calculated by the calculating unit 241 as well as provides an auction service.

By doing so, the service providing apparatus 200 according to the second embodiment allows the advertiser, who is a bidder, to grasp the prediction number of times the advertisement will be viewed by users even when the auction is held at the planning stage of the content. As a result, the Service providing apparatus 200 can provide the advertiser with a value-added service.

### 3. Modified Example

The aforementioned service providing apparatus 200 according to the second embodiment may also be implemented in various different types of forms other than the aforementioned embodiments. In this context, a description will be made below to another embodiment of the service providing apparatus 200.

3-1. Calculation Technique of the Predicted Number of PV

The aforementioned second embodiment illustrates the example in which the service providing apparatus 200 calculates the predicted number of PV on the basis of a prediction factor: “the views of the created content of which content creator coincides with that of the content being planned”; or “the views of the created content of which category coincides with that of the content being planned”. However, the calculating unit 241 may also calculate the predicted number of PV using a plurality of prediction factors.

For example, the calculating unit 241 may calculate the predicted number of PV using both “views of the created content matched with a content creator of content being planned” and “views of the created content matched with a category of content being planned”. Now, a description will be made to the example in which the calculating unit 241 generates a regression model (hereafter referred to as the “PV number model M1”) for each targeting condition from both the prediction elements, and calculates the predicted number of PV from the generated ?V number model M1. Note that it is assumed below that the calculating unit 241 creates the PV number model M1 of the targeting condition “male”.

First, the calculating unit 241 generates the PV number model M1, which shows the predicted number of PV by the creator ID or the category, by performing a regression analysis using the views stored in the history information storage unit 222 as a dependent variable (object variable) and the creator ID or the category stored in the history information storage unit 222 as an independent variable (explanatory variable). For example, the PV number model M1 calculated by the calculating unit 241 is expressed by the following Expression (1).

pv=a0·x0+a1·x1 (1)

In the above Expression (1), “pv” indicates views stored in the history information storage unit 222. In addition, “x0” indicates the average value of the views for each creator ID. In the example of FIG. 10, the views corresponding to the created content “CD11” and the targeting condition “male” is “160000”, and the views corresponding to the created content “CD12” and the Targeting condition “male” is “140000”. Thus, “x0” corresponding to the content creator CP11 is “150000”. Furthermore, “x1” indicates the average value of the views for each category. In the case of the example of FIG. 11, “x1” corresponding to the category “drama” is the average value “170000” of the views corresponding to the category “drama” and the targeting condition “male”.

For example, in the case of the created content “CD11” illustrated in FIG. 11, the views “pv” is “160000”. In addition, as in the example described above, “x0” corresponding to the content creator CP11 is “150000”, and “x1” corresponding to the category “drama” is “170000”. In this case, the above Expression (1) is expressed by the following Expression (2).

pv=a0·x0+a1·x1 (1)

160000=a0−(150000)+a1·(170000) (2)

Also for the created content “CD12” or “CD21”, the calculating unit 241 calculates the same expression as the above Expression (2). Then, the calculating unit 241 calculates “a0” and “a1”, which approximately satisfy each expression, by performing a regression analysis corresponding to each item of created content, and generates the PV number model M1 by applying the calculated “a0” and “a1” to the above Expression (1).

Then, when the plan information is received by the plan receiving unit 131, the calculating unit 241 calculates the predicted number of PV using the PV number model M1 expressed by above Expression (1). Specifically, the calculating unit 241 substitutes, for “x0” of Equation (1) above, the average value of the views of created content and the targeting condition “male” corresponding to the content creator who transmitted the plan information. Furthermore, the calculating unit 241 substitutes, for “x1” of Expression (1) above, the average value of the views of the created content and the targeting condition “male” corresponding to the category included in the plan information. This allows the calculating unit 241 to calculate the predicted number of PV of the content indicated by the plan information.

Thus, the service providing apparatus 200 can employ a plurality of prediction factors, thereby computing the predicted number of PV with high accuracy. As a result, the service providing apparatus 200 can provide the advertiser with a high value-added service.

In addition, in the above Expression (1), a linear model has been mentioned as an example. However, the calculating unit 241 may use a “log linear” model as in the following Expression (3) instead of the linear model.

pv=1/{1+exp(−(a0·x0+a1·x1))} (3)

3-2. Update of the Predicted Number of PV (1)

Furthermore, the plan receiving unit 131 of the service providing apparatus 200 which has been described above may also receive the plan information from the content creator multiple times in a stepwise manner. In this case, each time the plan receiving unit 131 receives new plan information, the calculating unit 241 may also calculate the predicted number of PV on the basis of the views of the created content corresponding to the new plan information. In case, the service providing unit 232 presents the predicted number of PV, which has been newly calculated by the calculating unit 241, and provides an auction service.

As described above, the service providing apparatus 200 may also receive the plan information multiple times in a stepwise manner. This allows the service providing apparatus 200 to implement a practical auction service for the content creator. For example, even when the content-plan has not been sufficiently studied, the content creator can transmit a simplified version of the content-plan to the service providing apparatus 200, thereby holding an auction. Then, the service providing apparatus 200 can calculate the predicted number of PV each time the plan information is received and thereby calculate the predicted number Of PV with high accuracy using the latest plan information, thus allowing for providing the advertiser with a high value-added service.

3-3. Update of the Predicted Number of PV (2)

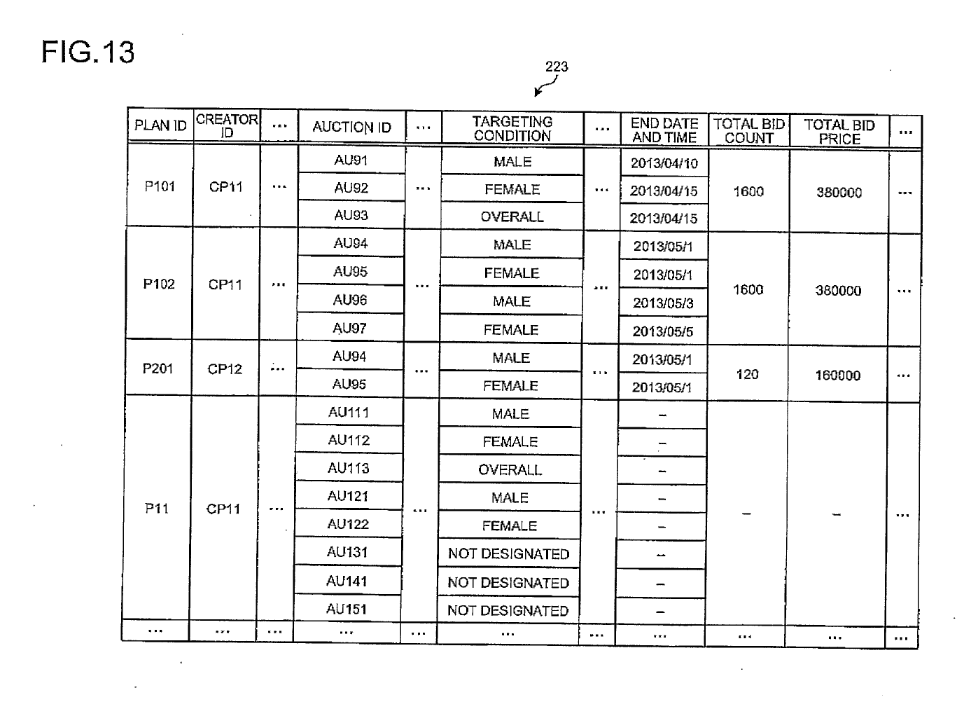

On the other hand, the service providing apparatus 200 may also update the predicted number of PV even when the plan information is not received in a stepwise manner. More specifically, while the service providing unit 232 is providing an auction service, the calculating unit 241 may also periodically calculate the predicted number of PV on the basis of the views of the created content corresponding to the auction information such as the bid count or the highest bid price. In this case, the service providing unit 232 presents the new predicted number of PV calculated by the calculating unit 241 and provides an auction service. Referring to FIG. 13, a description will be made to this point.

FIG. 13 is a diagram illustrating an example of an auction storage unit 223 according to a modified example. The service providing apparatus 200 according to the modified example has the auction storage unit 223 illustrated in FIG. 13 in place of the auction storage unit 221 illustrated in FIG. 10. As illustrated in FIG. 13, as an example of auction, information, the auction storage unit 223 stores information such as “total bid count” or “total bid price”. Note that although not illustrated in FIG. 13, the auction storage unit 223 also stores “content-plan”, “advertising space information”, “auction period”, “current price” and “bidder ID” which are illustrated in FIG. 4.

The “total bid count” indicates the total number of bids that have been tendered in each auction corresponding to the plan ID. The “total bid price” indicates the total amount of winning bid prices in each auction corresponding to the plan ID. These “total bid count” and “total bid price” are stored by the service providing unit 232 after all the auctions corresponding to the plan ID are ended. FIG. 13 illustrates the example in which each auction corresponding to the plan IDs “P101”, “P102” and “P201” has been ended, whereas each auction corresponding to the plan ID “P11” has not yet been ended. That is, the auction storage unit 223 illustrated in FIG. 13 stores, as history information, various types of information corresponding to the plan IDs “P101”, “P102” and “P201”.

Hare, on the basis of the completed auctions stored in the auction storage unit 223, the calculating unit 241 creates a regression model (hereafter referred to as the “the PV number model M2”) for computing the predicted number of PV from the total bid count or the total bid price. For example, the calculating unit 241 employs the views stored in the history information storage unit 222 as the dependent variable (object variable) and employs the total bid count or the total bid price stored in the auction storage unit 223 as the independent variable (explanatory variable) in order to perform the regression analysis, thereby creating the PV number model M2 indicative of the predicted number of PV by the total bid count or the total bid price. At this time, the calculating unit 241 employs the dependent variable (object variable) as the views for each targeting condition, thereby creating the PV number model M2 for each targeting condition.

Then, the calculating unit 241 periodically calculates the predicted number of PV using the PV number model M2 after the provision of an auction service has been held. Now, referring to the plan ID “P11” illustrated in FIG. 13 as an example, a description will be made to the computation process of the predicted number of PV.

First, the calculating unit 241 calculates the total bid count in each auction being held which corresponds to the plan ID “P11”, and the total amount of the current price (hereafter referred to as the “total bid price”). For example, these total bid count and total bid price are temporarily stored in a predetermined storage unit (which may also be the auction storage unit 223 or the like) by the service providing unit 232 while the auction is being held.

Then, on the basis of the calculated total bid count, the calculating unit 241 predicts the total bid count when each auction being held is ended. More specifically, on the basis of the auction period and the number of days elapsed from the auction starting day to the current day, the calculating unit 241 predicts the total bid count and the total bid price at the end of the auction. For example, on the basis of the history of auctions held in the past, the calculating unit 241 can predict the total bid count from the auction period and the number of elapsed days. Taking an example for illustration, it is assumed that as the auction history information relating to the auctions held in the past, the service providing apparatus 200 stores the period of the duration of each auction and the total bid count and the total bid price for each number of elapsed days. In this case, the calculating unit 241 analyzes the relation between the duration period and number of elapsed days and the total bid count and total bid price which are stored in the auction history information. This allows the calculating unit 241 to predict the total bid count and the total bid price at the end of each auction being held from the duration period and the number of elapsed days of each of such auctions being held. Then, the calculating unit 241 substitutes the predicted total bid count and total bid price for the PV number model M2 for each targeting condition, thereby computing the predicted number of PV for each targeting condition.

As described above, while the auction service is being provided, the service providing apparatus 200 may also sequentially update the predicted number of PV on the basis of various types of information relating to the auction (the bid count or the bid price). Here, since a lot of users are expected to view the content if the content-plan is outstanding, the bid count and the winning bid price of the auction tend to increase. And, when the content-plan is actually outstanding, the content generally tend to be viewed by an increased number of users. That is, the total bid count and the total bid price to be predicted by the calculating unit 241 while the auction is being held can be said to indicate the evaluation indicator of the content-plan. And, the aforementioned PV number model M2 can be said to indicate the relation between the evaluation indicator of the content-plan and the actual views. In this context, the calculating unit 241 can calculate the predicted number of PV with high accuracy using the PV number model M2.

3-4. Prediction Factor Used for Prediction

Furthermore, the aforementioned second embodiment illustrates the example in which employed by the service providing apparatus 200 as a prediction factor to be used to calculate the predicted number of PV are “the views of created content of which content creator coincides with that of the content being planned”, “the views of created content of which category coincides with that of the content being planned”, “total bid count”, and “total bid price”. However, the calculating unit 241 of the service providing apparatus 200 may also calculate the predicted number of PV using any other prediction factor than these prediction factors.

For example, the calculating unit 241 may also calculate the predicted number of PV using the following prediction factors: “the views of created content of which director coincides with that of the content being planned”, “the views of created content of which actor coincides with that of the content being planned”, “the views of created content of which reproduction time is equivalent to that of the content being planned”, “the views of created content of which number of advertising spaces is equivalent to that set to the content being planned”, or “the views of created content of which position of the advertising space is similar to that set to the content being planned”. In this case, the calculating unit 241 creates a PV number model using these prediction factors and then calculates the predicted number of PV from the created PV number model.

### OTHER EMBODIMENTS

The service providing system 1 according to each of the aforementioned embodiments may also be implemented in various different types of forms other than those of the aforementioned embodiments. In this context, a description will now be made to other embodiments of the service providing system 1. Note that a description will now be made to other embodiments mainly by taking the service providing apparatus 100 as an example. However, the other embodiments to be described below can also be applied to the service providing apparatus 200.

### 1. Provision of Targeting Condition

The service providing apparatus 100 described above may also provide the content creator (i.e., the creator terminal 10) with a candidate targeting condition that is set to the advertising space. Now, a description will be specifically made to this point. Note that in the descriptions below, it is assumed that the service providing apparatus 100 holds the history information storage unit 222 illustrated in FIG. 11. It is also assumed here that the plan receiving unit 131 receives the plan information, but does not receive the advertising space information. Or alternatively, it is assumed that the plan receiving unit 131 receives the plan information and the advertising space information that does not include the targeting condition.

First, of the created content stored in the history information storage unit 222, the plan receiving unit 131 identifies the created content related to the content that correspond to the plan intonation (hereafter referred to as the related content). For example, of the created content stored in the history information storage unit 222, the plan receiving unit 131 identifies, as the related content, the created content that is created in the past by the content creator who is the sender of the plan information. Subsequently, the plan receiving unit 131 acquires, from the history information storage unit 222, the targeting condition corresponding to the identified related content. Here, the targeting condition stored in the history information storage unit 222 can be said to be a user attribute of a user who viewed the related content. Thus, the plan receiving unit 131 is to acquire a user attribute from the history information storage unit 222. Then, the plan receiving unit 131 provides the content creator or the sender of the plan information with the targeting condition (the user attribute in this example) acquired from the history information storage unit 222. For example, the plan receiving unit 131 provides the content creator with a selection window on which the targeting condition acquired from the history information storage unit 222 can be selected. At this time, when having received the advertising space information that includes no targeting condition, the plan receiving unit 131 provides a selection window on which a targeting condition can be selected for each advertising space included in the advertising space information. Then, the plan receiving unit 131 receives, as the advertising space information, the targeting condition selected on such a selection window.

On the other hand, without being limited to the aforementioned example, the invention may also be configured such that of the created content stored in the history information storage unit 222, the plan receiving unit 131 may also identify, as the related content, those created content of which category coincides with that included in the plan information, and then provide the content creator with the targeting condition corresponding to the identified related content.

As described above, the service providing apparatus 100 can provide the content creator with the user attribute of a user who viewed the related content associated with the content being planned, thereby allowing the content creator to set an appropriate targeting condition to the advertising space. By doing so, the service providing apparatus 100 can provide the content creator with a high value-added service. Furthermore, the service providing apparatus 100 can prevent degradation in the effects of an advertisement by allowing the content creator to set an appropriate targeting condition to the advertising space. As a result, it is possible to provide the advertiser with a high value-added service.

### 2. View User of Related Content

Furthermore, the service providing apparatus 100 described above may present the user attribute relating to the destination user of the related content associated with the content corresponding to the plan information as well as provide the auction service which has been described above. Now, a description will be made specifically to this point. Note that it is assumed that like the aforementioned example, the service providing apparatus 100 retains the history information storage unit 222 illustrated in FIG. 11 and has not received at least a targeting condition.

First, like the plan receiving unit 131 of the aforementioned example, the service providing unit 132 references the history information storage unit 222 to identify the related content associated with the content corresponding to the plan information and then acquires the targeting condition (i.e., user attribute) corresponding to the identified related content. Then, the service providing unit 132 presents, to the advertiser, the user attribute that is the targeting condition acquired from the history information storage unit 222. For example, the service providing unit 132 publicizes, for example, the ratio of a user attribute on the auction page W10 illustrated in FIG. 5. Taking an example, the service providing unit 132 publicizes, on the auction page W10 as the information on users who actually viewed the related content of the content being planned, information such as “male: 30%, female: 70%” or information such as “residents in Kanto area 40%, residents in Kansai area: 40%, Others: 20%”.

As described above, the service providing apparatus 100 publicizes, on the auction page, the user attribute of users who viewed the related content associated with the content being planned, thereby providing the advertiser with information useful for bidding. For example, the advertiser can view the distribution of user attributes, thereby grasping the tendency of users who will possibly view the content being planned. For this reason, the advertiser can bid for the advertising space that includes the setting of the targeting condition that matches the needs of the advertiser. In this context, the service providing apparatus 100 can provide the advertiser with a value-added service.

### 3. Distribution Target User

Furthermore, the service providing apparatus 100 described above may present information relating to users for whom the content being planned are targeted as well as may also provide the auction service described above. More specifically, when planning the production of content, the content creator may often study on the target layer of the content. For example, the content creator may plan the production of female-oriented content; may plan the production of male-oriented content; or may plan the production of child-oriented content.

In this context, the plan receiving unit 131 receives the plan information that includes information relating to distribution target users of the content from the content creator. Then, the service providing unit 132 publicizes, on an auction page, information relating to those distribution target users on the basis of the plan information received by the plan receiving unit 131. For example, the service providing unit 132 publicizes “male-oriented content” or “female-oriented content” on the auction page.

As described above, the service providing apparatus 100 publicizes, on the auction page, the information relating to target users of the content being planned, thereby providing the advertiser with information that can be referred to for bidding. In this context, the service providing apparatus 100 can provide the advertiser with a value-added service.

### 4. Targeting condition

Furthermore, the aforementioned embodiments have been described by illustrating, by way of example, the sex of users as the targeting condition that is set to the advertising space. However, the advertising space that is set to the targeting condition is not limited to the sex of users, but may also be another demographic attribute or a psychographic attribute. Furthermore, for example, as illustrated in FIG. 4, the aforementioned embodiments have been described in accordance with an example in which one targeting condition is set to each auction. However, a plurality of targeting conditions may also be set. For example, the auction storage unit 121 illustrated in FIG. 4 may also store the targeting condition “male and age in twenties” associated with one auction ID.

### 5. Combined Auction

Furthermore, for example, as illustrated in FIGS. 6 and 7, the aforementioned embodiments have been illustrated in which when overlapped targeting conditions are set, such a combination of auctions that maximizes the total of winning bid prices is established. However, even when overlapped targeting conditions are set, the service providing unit 132 may also establish each auction. For example, in the example of FIG. 6, the service providing unit 132 may also employ the advertisers C11 to C13 as the winning bidder. In this case, the generating unit 135 creates composite content with the advertisement data of the advertiser C11 incorporated in the advertising space A, composite content with, the advertisement data of the advertiser C12 incorporated in the advertising space A, and composite content with the advertisement data of the advertiser C13 incorporated in the advertising space A. Then, the transmitting unit 136 transmits, to the distribution server 30, the combination between the composite content generated by the generating unit 135 and the targeting condition. By doing so, the distribution server 30 distributes, to the user terminal 40, the composite content with the targeting condition that coincides with the user attribute of the destination user. For example, the distribution server 30 distributes the composite content with the advertisement data of the advertiser C11 incorporated therein when the destination user is male, whereas the composite content with the advertisement data of the advertiser C12 incorporated therein is distributed thereto when the destination user is female. Furthermore, when the sex of the destination user is unknown, the distribution server 30 distributes the composite content with the advertisement data of the advertiser C13 incorporated therein. Note that the service providing unit 132 may also publicize such a distribution condition on the auction page.

### 6. Service Mode

Also illustrated was the example in which the service providing apparatus 100 provides an auction service to bid for the advertisement right of displaying an advertisement in the content being planned. However, for example, the service providing unit 132 of the service providing apparatus 100 may also provide an auction service to bid for the right of displaying an advertisement not in the content being planned but in already completed content. Furthermore, the aforementioned embodiments have been described with, reference to the example in which the service providing apparatus 100 produces composite content. However, the production of the composite content may also be implemented by any other unit such as the distribution server 30. In such a case, the service providing apparatus 100 illustrated in FIG. 3 may not have to include, for example, the plan receiving unit 131, the content receiving unit 134, and the generating unit 135. Furthermore, the auction storage unit 121 illustrated, for example, in FIG. 4 may not store, for example, “the plan ID” or “the content-plan”.

### 7. Type of Content

In the above-described embodiments, the moving image is mainly given as an example of the content. However, the type of content is not limited to the moving image. Examples of the content may include applications, such as games, electronic books, and web pages, such as weblogs. For example, when the content creator plans to create games, electronic books, or professional web pages, the content creator can use the above-mentioned auction service.

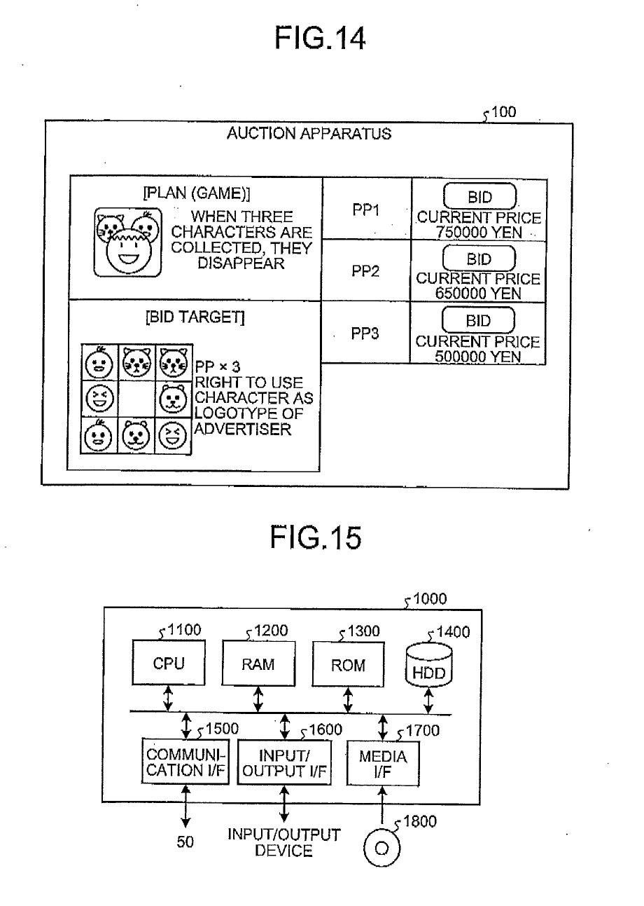

FIG. 14 illustrates an example of content according to another embodiment. FIG. 14 illustrates an example where the content is a game. In the example illustrated in FIG. 22, the content creator plans to create a game using character icons. The content creator sets three icons among plural types of icons as advertising spaces. As such, the above-mentioned auction service can also be applied to content, such as a game.

In addition, in the example of FIG. 14, similarly to the product placement, the content creator receives an icon image or the like for advertising from the advertiser, who is a winning bidder, and creates a game using the received icon image. As a result, the content creator creates composite content (in this example, a game) including advertisement data.

### 8. Program

In addition, the service providing apparatuses 100 and 200 according to the embodiments described above are realized by a computer 1000 configured as illustrated in FIG. 15, for example. Hereinafter, the service providing apparatus 100 will be described as an example. FIG. 15 is a hardware block diagram illustrating an example of the computer 1000 to realize the function of the service providing apparatus 100. The computer 1000 includes a CPU 1100, a RAM 1200, a ROM 1300, an HDD 1400, a communication interface (I/F) 1500, an input/output interface (I/F) 1600, and a media interface (I/F) 1700.

The CPU 1100 operates based on a program stored in the ROM 1300 or the HDD 1400, and controls each unit. A boot program executed by the CPU 1100 at the start of the computer 1000, a program depending on the hardware of the computer 1000, and the like are stored in the ROM 1300.

The HDD 1400 stores a program executed by the CPU 1100 and data used by the program. The communication interface 1500 receives data from other apparatuses through the communication network 50 and transmits the data to the CPU 1100, and transmits the data generated by the CPU 1100 to other apparatuses through the communication network 50.

The CPU 1100 controls an output device, such as a display or a printer, and an input device, such as a keyboard or a mouse, through the input/output interface 1600. The CPU 1100 acquires data from an input device through the input/output interface 1600. In addition, the CPU 1100 outputs the generated data to an output device through the input/output interface 1600.

The media interface 1700 reads a program or data stored in a recording medium 1800, and provides it to the CPU 1100 through the RAM 1200. The CPU 1100 loads the program onto the RAM 1200 from the recording medium 1800 through the media interface 1700, executes the loaded program. The recording medium 1800 is, for example, an optical recording medium such as a digital versatile disc (DVD) or a phase change rewritable disk (PD), a magneto-optical recording medium such as a magneto-optical disk (MO), a tape medium, a magnetic recording medium, or a semiconductor memory.

For example, when the computer 1000 functions as the service providing apparatus 100 according to the embodiment, the CPU 1100 of the computer 1000 realizes the function of the control unit 130 by executing the program loaded onto the RAM 1200. In addition, data in the auction storage unit 121 is stored in the HDD 1400. The CPU 1100 of the computer 1000 reads these programs from the recording medium 1800 and executes them. However, as another example, these programs may be acquired from other apparatuses through the communication network 50.

### 9. Others

Among the respective processes described in the above embodiment, all or some of the processes described to be automatically performed can also be manually performed, or all or some of the processes described to be manually performed can also be automatically performed. In addition, information including the procedure, specific names, various kinds of data, or parameters, which are illustrated in the diagrams or specification described above, can be arbitrarily changed unless otherwise specified.

For example, the various kinds of information illustrated in the respective diagrams are not limited to the illustrated information. In addition, although the example where a plurality of advertising spaces are set on the same content is illustrated in each embodiment described above, one advertising space may be set on the same content, for example.

In addition, in the embodiment described above, an example is illustrated in which the content creator sets the reproduction position, reproduction time, or the like of the advertising space on the content. However, the service providing apparatus 100 may receive only plan information from the content creator, and may not receive advertising space information. In this case, the service providing apparatus 100 sets, for example, an advertising space of the reproduction position or reproduction time determined in advance on the content.

In addition, although the example where composite content obtained by incorporating advertisement data into content is distributed to the user terminal 40 is illustrated in each embodiment described above, for example, advertisement data may be distributed to the user terminal 40 by an advertisement server (called an ad server or the like), which is not illustrated in FIG. 2, whenever the content is displayed or reproduced by the user terminal 40. Specifically, the generating unit 135 of the service providing apparatus 100 may generate composite content by incorporating information on access (for example, URL: Uniform Resource Locator) to the advertisement server into the advertising space of content. In this case, the user terminal 40 accesses an advertisement server based on the access information set to the advertising space. Then, the advertisement server distributes the advertisement data incorporated into the content to the user terminal 40 when there is an access from the user terminal 40. In this case, the advertisement server selects advertisement data to be distributed, for example, based on the user attributes of the accessing user. Then, the user terminal 40 displays the advertisement data acquired from the advertisement server in the advertising space of the content. In addition, in this example, the advertiser may transmit access information for accessing a moving image, a still image, or the like, which is an advertisement, to the service providing apparatus 100 as advertisement data.

In addition, each component of each apparatus illustrated in the diagrams is a functional and conceptual component, and does not necessarily need to be physically configured as illustrated in the diagrams. That is, specific forms of distribution and integration of each apparatus are not limited to those illustrated in the diagrams, and all or some of distributed and integrated components may be configured to be distributed and integrated functionally or physically in arbitrary units depending on various types of loads, use conditions, or the like. For example, the plan receiving unit 131 and the content receiving unit 134 illustrated in FIG. 3 may be integrated. In addition, for example, the service providing apparatus 100 described above may be integrated with the distribution server 30.

In addition, the respective embodiment described above can be appropriately combined to the extent that the processing content is consistent.

In addition, the above-described sections, modules, units can be read as “means”, “circuits”, and the like. For example, the plan receiving unit can be read as a plan receiving unit or a planning receiving circuit.

An aspect of an embodiment produces an effect that value-added services can be provided to advertisers.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A service providing apparatus comprising:
a receiving unit configured to receive advertising space information relating to an advertising space set to content by a content creator who creates the content and a targeting condition set to the advertising space by the content creator; and
a providing unit configured to provide an auction service in which a bid target is a right to display an advertisement in the advertising space for each targeting condition on the basis of the advertising space information received by the receiving unit.

2. The service providing apparatus according to claim 1, wherein
when some of a plurality of targeting conditions set to the advertising space overlap each other, the providing unit gets a combination of auctions done, the combination of the auctions having targeting conditions which do not overlap each other and maximizing the total of winning bid prices among a plurality of auctions corresponding to the plurality of targeting conditions.

3. The service providing apparatus according to claim 1, wherein
the receiving unit provides the content creator with a user attribute relating to a user, the user having viewed created content that is associated with the content among created contents that were created in the past, and receives, as a targeting condition, a user attribute selected by the content creator from the user attributes provided.

4. The service providing apparatus according to claim 1, wherein
the providing unit presents a user attribute relating to a destination user of the created content that is associated with the content among created contents that were created in the past, and provides the auction service.

5. The service providing apparatus according to claim 3, wherein
the providing unit uses the created content, which the content creator created in the past, among the created content as the created content associated with the content.

6. The service providing apparatus according to claim 1, wherein
the receiving unit receives plan information indicating a plan of the content; and
the providing unit presents the plan information received by the receiving unit and provides the auction service.

7. The service providing apparatus according to claim 6, wherein
the receiving unit receives the plan information including information relating to a distribution target user of the content; and
the providing unit presents the distribution target user on the basis of the plan information received by the receiving unit and provides the auction service.

8. The service providing apparatus according to claim 6, further comprising a calculating unit configured to calculate a prediction value of a number of times in which the content corresponding to the plan information is viewed by users on the basis of the plan information when the plan information is received by the receiving unit, and wherein
the providing unit presents the prediction value calculated by the calculation unit and provides the auction service.

9. A service providing method executed by a computer, comprising:
receiving advertising space information which is related to an advertising space set to content by a content creator who creates the content and which is related to a targeting condition set to the advertising space by the content creator; and
providing an auction service in which a bid target is a right to display an advertisement in the advertising space for each targeting condition on the basis of the advertising space information received at the receiving.

10. A non-transitory computer-readable storage medium with an executable program stored thereon, wherein the program instructs a computer to perform:
receiving advertising space information which is related to an advertising space set to content by a content creator who creates the content and which is related to a targeting condition set to the advertising space by the content creator; and
providing an auction service in which a bid target is a right to display an advertisement in the advertising space for each targeting condition on the basis of the advertising space information received at the receiving.
